(19) United States
(12) Patent Application Publication
(10) Pub. No.: US 2026/0095208 A1
(43) Pub. Date: Apr. 2, 2026

(54) System for Localized Position, Navigation, and Timing Using a Distributed Aperture Array of Multiple Transmit Antennas

(71) Applicant: Propagation Research Associates, LLC, Marietta, GA (US)

(72) Inventor: Ernest Jefferson Holder, Canton, GA (US)

(21) Appl. No.: 18/822,054

(22) Filed: Aug. 30, 2024

Related U.S. Application Data
(60) Provisional application No. 63/535,982, filed on Aug. 31, 2023.

(51) Int. Cl. H04B 7/04; H04B 7/0413

(52) U.S. Cl. CPC H04B 7/04013; H04B 7/0413

(57) ABSTRACT

A system includes a receiver, processor, repeater, and second processor. The receiver receives a set of N uniquely coded signals transmitted by a spatially distributed architecture (SDA) of transmit antenna arrays, the SDA having at least N members separate from each other, the N members transmitting uniquely coded signals respectively, where relative phases among the N uniquely coded signals are known, a position and orientation of the antenna arrays of the SDA identifying a localized coordinate system. The processor determines the interferometric phase differences of the N received signals. The repeater transmits the N received signals received at the receiver. At least one of the transmit antenna arrays or an antenna proximal to the SDA transmits a combination signal including the set of N uniquely coded signals and receives the combination signal from the repeater. The second processor determines an angle of incidence of the combination signal from the repeater.

### CROSS-REFERENCE TO RELATED APPLICATIONS

This application is a U.S. non-provisional patent application and claims the benefit of the filing date of the U.S. provisional patent application No. 63/535,982, filed Aug. 31, 2023, the disclosure of which is incorporated herein by reference in its entirety.

### TECHNICAL FIELD

Embodiments disclosed herein relate to a system for localized position, navigation, and timing.

### BACKGROUND ART

Global positioning systems are well known. Such systems use a constellation of satellites to transmit one-way signals that identify satellite position and time. A control segment consists of ground stations that track the satellites, maintain proper orbits, and adjust satellite clocks. The constellation of satellites and the control segment work together to provide a global positioning capability for both civilian and military-enabled receivers to calculate the receiver's three-dimensional position and time. The information to develop and build equipment to use the civilian services of the U.S. global positioning system (GPS) is accessible on publicly available networks.

U.S. Pat. No. 8,120,526 B2 describes a system where multiple encoded signals transmitted from spatially distributed transmitters are received by a receiver. An accurate time of arrival of each of the encoded signals are determined, from which the path lengths from the transmitters to the receiver and from the transmitters to an object are determined. From this information, the receiver determines its own position, motion, and orientation (roll, pitch, and yaw) as well as the position and motion of the object.

U.S. Pat. Nos. 9,696,418 B2, 10,571,224 B2, 11,353,290 B2 describe systems for navigating a platform in a SDA (spatially distributed array (of antennas)) defined coordinate system. One or more platforms use a self-determined position, and a position of a non-cooperative object communicated from the SDA to navigate or guide the platform relative to the non-cooperative object. Any of the platforms may also use its self-determined position and information from an alternative signal source in a second coordinate system to guide itself in either coordinate system.

### SUMMARY

There may be a need to provide a system and a method that enables localized position, navigation, and timing in an environment where GPS signals are unavailable due to one or more failures with the satellites, ground station failures to maintain orbits and satellite clocks, or where the GPS signals are otherwise unusable such as in environments with local electromagnetic interference.

According to an aspect of the disclosure, there is described a system for localized position, navigation, and timing. The system includes at least a cooperative platform and a SDA of transmit antennas. The cooperative platform includes a first receive antenna, a first processor in communication with the first receive antenna and may include a repeater. The first receive antenna receives a set of a set of N uniquely coded signals transmitted by a spatially-distributed architecture (SDA) of transmit antenna arrays, the SDA having at least N members of antenna arrays separate from each other, the N members of antenna arrays transmitting uniquely coded signals, respectively, where the relative phases among the N uniquely coded signals is known, and where N is an integer greater than or equal to two. The receiver or first receive antenna receives a set of N uniquely coded signals transmitted by the SDA of transmit antennas, the SDA having at least N members of antenna arrays separate from each other, where N is an integer equal to or greater than two. The N members of antenna arrays transmit uniquely coded signals respectively and the relative phases among the N uniquely coded signals is known. A position and an orientation of the antenna arrays of the SDA identify a localized coordinate system consisting of at least two orthogonal axes. A first processor in communication with the first receive antenna processes the received SDA signals to determine the interferometric phase differences among the N transmitted SDA signals as received at the first receive antenna. A repeater coupled with the first receive antenna or a reflective non-cooperative platform, where the repeater transmits the set of N uniquely coded signals as received at the first receive antenna or where the non-cooperative platform reflects the set of N uniquely coded signals incident at the non-cooperative platform. At least one of the transmit antennas or an antenna proximal to the SDA combines and transmits a combination signal including the set of N uniquely coded signals and receives the combination signal from the repeater or a reflected version of the set of N uniquely coded signals. An SDA processor in communication with the transmit antennas or the antenna proximal to the SDA determines an angle of incidence of the combination signal as received from the repeater.

According to a second aspect of the disclosure, there is described a combined signal calibration method. The method includes i) transmitting a combined signal that includes the N uniquely coded signals transmitted by the SDA antennas; ii) receiving the combined signal with one of the SDA antennas or an antenna proximal to the SDA antennas; iii) identifying the N uniquely coded signals as received; iv) determining the received relative phases of the N uniquely coded signals as received; v) determining an angle calibration bias factor using the known relative phases and the received relative phases of the N uniquely coded signals; and vi) adjusting estimated angles using the angle calibration bias factor.

According to a third aspect of the disclosure, there is described a method for localized time synchronization (LTS). The method includes i) determining the location of a reflective non-cooperative platform, a repeater or cooperative platform arranged with the repeater with a receiver processor on a primary platform using an SDA clock; ii) determining the location of the receiver on the primary platform using the N uniquely coded signals transmitted by the SDA and received at the primary platform; iii) determining the range from the SDA array to the reflective non-cooperative platform, repeater, or repeater on the cooperative platform, using the clock on the primary platform; iv) determining a clock correction factor with the estimates of range to the repeater.

A first clock correction is made by the first processor on the primary platform to align the SDA clock frequency with the local clock frequency operating on the primary platform. Once the SDA clock and the primary platform clock are operating at approximately the same frequency the primary platform can use two range estimates and a function of the angles of incidence at the SDA to identify a clock signal bias. Once the clock signal bias is determined, the primary platform processor can align or set a primary platform clock start time with a SDA clock start time by removing the clock signal bias from the primary platform clock.

### Overview of Embodiments

In an exemplary embodiment, a position, navigation, and timing (PNT) system provides a PNT capability to a functionally enabled receiver in a localized region. For some applications PNT is only required over a limited coverage area due to the need for covertness or the need to operate with enhanced capability in a specific area. A Localized PNT (LPNT) system uses a spatially distributed array (SDA) of antennas that are transmitting uniquely coded waveforms to create a radiated energy field within which a functionally enabled receiver can execute accurate PNT.

One of the primary challenges to achieving accurate PNT is establishing clock synchronization and alignment across all the participating receivers. In particular, the use of asynchronous receiver clock signals can cause range estimates from the transmitting antennas to the receiver(s) to be in error. Whereas GPS uses various ranging methods that require relative time to estimate clock errors and to correct range errors, the disclosed LPNT system cannot take advantage of these GPS ranging methods. In this regard, another method is developed called the Localized Time Synchronization (LTS) method that synchronizes time between the SDA and a functionally enabled receiver using a repeater. The repeater may be present on a common platform with the functionally enabled receiver. In addition, the repeater may be remote from the functionally enabled receiver and may be located on a separate cooperative platform. In the illustrated embodiments, a cooperative platform is arranged with a repeater and a primary platform separate from the cooperative platform is arranged with the functionally enabled receiver.

That is, the LPNT system uses a spatially distributed array (SDA) of N antennas that are transmitting N uniquely coded signals, a cooperative platform with a repeater that is receiving and re-transmitting the N uniquely coded signals, at least one primary platform with a functionally enabled receiver, and an up-link capability from the SDA to the primary platform receiver/processor allowing PNT to be enabled on the primary platform. The primary clock is the SDA clock, and thus, the LTS method aligns the remaining system clocks (e.g., a primary platform clock and optionally a cooperative platform clock) with the SDA clock. A processor communicatively coupled with each receiver determines the PNT measurements. Again, it may be preferable for the cooperative platform to be configured as a repeater and for a single primary platform to be enabled to coordinate the various clock signals.

For each primary platform the LTS method uses two estimates of the range from the SDA to the cooperative platform-one estimate of range uses the SDA clock to establish time of signal arrival and range R₁, and the other estimate of range uses the primary platform clock to establish an estimate of time of arrival and range R₂. The range R₂ is the distance between the cooperative platform and the primary platform. It can be shown that the difference in the range estimates R₁ and R₂ is functionally related to the clock time bias which can be derived. Once the clock time bias is derived the system clocks can be aligned. For example, the system clocks may be aligned by removing the derived clock time bias from the primary platform clock.

An efficient method to accomplish time synchronization between a transmitter and receiver with minimal energy is enabled by associating a receiver with a repeater. An SDA processor can estimate the range R₁ using the returned combination signal (similar to a radar reflected signal) and the receiver in the primary platform can estimate the range R₂ using the direct path signal from the repeater. However, for applications using multiple platforms increasing the number of repeaters adds complexity and vulnerability. The LTS method can deploy one repeater located on a cooperative platform regardless of the number of platforms located in the LPNT energy field.

The impact of clock asynchronization on range estimates can be quantified as follows. Assume the primary platform clock frequency fₚ is different from the SDA clock frequency by Δf then,

$${f}_{P} = f + Δ f .$$

However, the primary platform clock sample time interval is

$${T}_{P} = \frac{1}{{f}_{P}} = \frac{1}{f + Δ f}$$

and the SDA clock sample time interval is

$${T}_{S D A} = \frac{1}{f} .$$

Thus, the proportional relationship of the two sample times is

$$Δ = \frac{{T}_{P}}{{T}_{SDA}} = \frac{\frac{1}{f + Δ f}}{\frac{1}{f}} = \frac{1}{1 + \frac{Δ f}{f}} .$$

When T is the time that a pulse that travels from the SDA to a platform with a repeater and back to the SDA, the range from the SDA to the platform (e.g., a cooperative platform) using the SDA clock is given by

$${r}_{a} = \frac{c T}{2} .$$

But for a receiver located on the primary platform which uses a time biased clock signal, the range is given by

$${r}_{b} = \frac{cT}{2} Δ = {r}_{a} Δ .$$

Since the primary platform may not have a repeater, the signal-to-noise ratio (SNR) of the SDA transmitted signal received by the SDA receiver depends on the radar cross section (RCS) of the primary platform. As such, significant transmit power may be required to achieve the accuracies needed for accurate PNT. To minimize the transmit power required for a PNT system, the LPNT system may use a single repeater on a cooperative platform rather than a repeater on a primary platform.

The LPNT system uses angle of arrival estimates together with the bias adjusted or synchronized clock signals. In particular, two angles are estimated-one is the angle of the cooperative platform relative to the SDA and the other is the angle of the primary platform relative to the SDA. These angles are measured in a coordinate frame defined by the plane of the SDA antennas and an array normal vector extending orthogonal to the plane. The LTS method uses estimates of these two angles using information relative to both the SDA clock and the primary platform clock. A combined signals calibration (CSC) method is implemented using a single angle calibration antenna (ACA) located in proximity of the SDA to avoid or reduce angle measurement bias. In some embodiments, one of the antenna arrays of the SDA array of transmit antennas may serve as the calibration antenna.

The CSC method deploys a combination of the N uniquely coded signals in a (combination) signal where the relative phase differences among the N uniquely coded signals are known. The combined signal is transmitted and received by an antenna that is either located in proximity of the SDA or is one of the N SDA antennas.

A receiver/processor receives the combined signal and processes the combined signal with N correlation filters using the N uniquely coded signals as reference signals for the correlation process. Thus, the relative phases of the N signals are determined through the correlation process. Using the known relative phases and the received and correlated relative phases, an angle calibration bias factor can be determined and removed from the angle estimates. The CSC method enables the LPNT method to achieve accurate PNT but can also be used for other applications of interferometry including with a bistatic receiver that is not collocated with the CSC transmit antenna.

A first step of the LTS method determines the location of the repeater on the cooperative platform at the receiver/processor located on the primary platform using the SDA clock. To accomplish this first step, the SDA acts like a radar by using the 2-way signal from the repeater to determine the angle of arrival and the range of the repeater in the SDA coordinate system and then communicates this information to the primary platform receiver using a data link. FIG. 3 illustrates the functional components of a system that can execute the first step of the LTS method.

A second step of the LTS method determines the location of the receiver on the primary platform using the N transmitted signals by the SDA and received by the receiver on the primary platform. To accomplish this the relative phases of the N signals and the time of arrival of at least one of the N signals are determined by the receiver/processor relative to the SDA array. FIG. 4 illustrates the functional components of a system that can execute the second step of the LTS method.

A third step of the LTS method determines the range from the SDA array to the repeater on the cooperative platform using the clock on the primary platform. FIG. 5 shows the functional components of a system that can execute the third step of the LTS method where an angle, α, is functionally related to the angles β and γ. More particularly, the angle α, is the sum of the angles β and γ, where γ is the angle from the normal vector extending from the SDA to the repeated versions of the N uniquely coded signals from the cooperative platform and β is the angle from the normal vector extending from the SDA to the primary platform. Using geometry and considering the relationships illustrated in FIG. 5,

$${r}_{1} = \frac{{r}_{12}^{2} - {r}_{3}^{2}}{2 ( {r}_{12} - {r}_{3} cos ( α ) )} where {r}_{12} = {r}_{1} + {r}_{2} .$$

A fourth step of the LTS method determines a clock correction factor Δ. From step 1 we have an estimate of r₁ using the SDA clock and from steps 2 and 3 we have an estimate of r₁ using the primary platform clock denoted as \hat{r}₁.

Now r₁ is erred due to the clock misalignment (i.e., includes an error when the clocks are misaligned) and,

$${\hat{r}}_{1} = \frac{{\hat{r}}_{12}^{2} - {\hat{r}}_{3}^{2}}{2 ( {\hat{r}}_{12} - {\hat{r}}_{3} cos ( α ) )} = \frac{{( {r}_{12} + {r}_{1} Δ + {r}_{2} Δ )}^{2} - {( {r}_{3} + {r}_{3} Δ )}^{2}}{2 ( {r}_{12} + {r}_{1} Δ + {r}_{2} Δ - ( {r}_{3} + {r}_{3} Δ ) cos ( α ) )}$$

Using differential calculus,

$${\frac{d \hat{r}}{d Δ} \vert}_{Δ = 0} = {r}_{1}$$

which when represented as a first order Taylor series becomes,

$${\hat{{r}_{1}} = {r}_{1} + \frac{d \hat{r}}{d Δ} \vert}_{Δ = 0} Δ + O ( {Δ}^{2} ) = {r}_{1} + {r}_{1} Δ + O ( {Δ}^{2} ) .$$

Or to first order assuming that the cooperative and primary platform velocities are linear,

$$\hat{{r}_{1}} = {r}_{1} + {r}_{1} Δ .$$

Measurement time latency will result in a range bias that can degrade measurement accuracy. Assume that there is a latency in the measurement of r₁ because of the time required to communicate r₁ to the primary platform processor. If the latency is denoted by δ the range estimate becomes,

$$\hat{\hat{{r}_{1}}} = {r}_{1} + {\dot{r}}_{1} δ .$$

Using range to estimate the clock bias will benefit from apriori knowledge of the latency which is not always available. Assuming that the latency term is a constant function of time, using differentiation, the range rate can be determined as,

$$\dot{\hat{\hat{{r}_{1}}}} = {\dot{r}}_{1}$$

(using the SDA clock).

The range rate for r₁ using the SDA clock can be determined from the equation below as,

$${\dot{r}}_{1} = \frac{2 {r}_{12}^{2} {\dot{r}}_{12} - 2 {r}_{3} {\dot{r}}_{3}}{2 ( {r}_{12} - {r}_{3} cos ( α ) )} - \frac{( {r}_{12}^{2} - {r}_{3}^{2} ) ( {\dot{r}}_{12} - {\dot{r}}_{3} cos ( α ) + {r}_{3} sin ( α ) \dot{α} )}{2 {( {r}_{12} - {r}_{3} cos ( α ) )}^{2}} .$$

For this computation r₃, α and r₁₂ are measured using the primary platform clock, and thus, are not delayed. As a result, the clock bias A can be estimated from

$$Δ = \frac{\dot{\hat{{r}_{1}}} - \dot{\hat{\hat{{r}_{1}}}}}{\dot{\hat{\hat{{r}_{1}}}}} .$$

Also, once the primary clock adjusts its clock to account for any bias (when present) the latency term can be computed by taking the difference between the corrected range measured by the corrected primary platform clock and the up-linked range measured by the SDA clock and communicated to the primary platform.

$$δ = \frac{\hat{\hat{{r}_{1}}} ( 1 + Δ ) - \hat{{r}_{1}}}{\dot{\hat{{r}_{1}}}}$$

Since the range and range rate measurements may vary due to random noise (i.e., these measurements may be erroneous because of noise) the estimate of Δ and δ can be more effectively accomplished using an optimal estimator such as a Kalman filter or a maximum likelihood estimator.

Assuming the velocity of the cooperative platform is constant over the measurement interval, the parameters to be estimated are given by the vector X,

$$X = {[ \begin{matrix}{r}_{1} \\ \dot{{r}_{1}} \\ Δ \\ δ\end{matrix} ]}_{k} = {[ \begin{matrix}1 & dt & 0 & 0 \\ 0 & 1 & 0 & 0 \\ 0 & 0 & 1 & 0 \\ 0 & 0 & 0 & 1\end{matrix} ] [ \begin{matrix}{r}_{1} \\ \dot{{r}_{1}} \\ Δ \\ δ\end{matrix} ]}_{k - 1}$$

The measurements are given by the vector Z,

$$Z = [ \begin{matrix}\hat{{r}_{1}} \\ \dot{\hat{{r}_{1}}} \\ \hat{\hat{{r}_{1}}} \\ \dot{\hat{\hat{{r}_{1}}}} \\ \hat{Δ} \\ \hat{δ}\end{matrix} ] = [ \begin{matrix}{r}_{1} + {r}_{1} Δ \\ \dot{{r}_{1}} + \dot{{r}_{1}} Δ \\ {r}_{1} + δ \\ \dot{{r}_{1}} \\ Δ \\ δ\end{matrix} ] = [ \begin{matrix}{r}_{1} + {r}_{1} Δ \\ \dot{{r}_{1}} + \dot{{r}_{1}} Δ \\ {r}_{1} + \dot{{r}_{1}} δ \\ \dot{{r}_{1}} \\ ( \dot{\hat{{r}_{1}}} - \dot{\hat{\hat{{r}_{1}}}} ) / \dot{\hat{\hat{{r}_{1}}}} \\ ( \hat{\hat{{r}_{1}}} ( 1 + Δ ) - \hat{{r}_{1}} ) / \dot{\hat{{r}_{1}}}\end{matrix} ] = h ( X )$$

The maximum likelihood estimate is defined by,

$${min}_{{r}_{1} , \dot{{r}_{1}} , Δ , δ} ( {\vert X - h ( X ) \vert}^{2} ) .$$

An iterative optimal search algorithm can be used to find the values for r₁, \dot{r}₁, Δ and δ. Also, if the velocities (with respect to the plane of the SDA) of the cooperative platform are not linear then higher order derivatives of the range r can be used to generate and estimate of Δ and δ.

In an embodiment of the LPNT system, the relative phases among the combined waveforms in the combination signal transmitted by the at least one of the transmit antenna arrays of the SDA or the antenna proximal to the SDA are computed by a processor in communication with the receiver. In this example embodiment, combined signals in the combination signal transmitted by the at least one of the transmit antenna arrays or the antenna proximal to the SDA are compared with the known relative phases. The processor uses interferometric phase differences among the N uniquely coded signals and determines the angular location of the receiver in the localized coordinate system. In this embodiment, a calibration of the relative interferometric phases is achieved using a comparison of the relative signal phases in the received combination signal and the known relative phases of the N uniquely coded signals to derive an angle calibration factor. The angle calibration factor is used to adjust estimated angles of the cooperative platform and a primary platform relative to a normal vector extending from a plane defined by the SDA transmit antenna arrays.

In an embodiment of the LPNT system, the SDA array, the ACA antenna, and the first receive antenna are collocated, and the N transmitted SDA signals are reflected from a non-cooperative platform (not shown) or reradiated from a cooperative platform.

An alternative embodiment of the LPNT system includes a second receive antenna located on a primary platform separate from the cooperative platform that receives the N uniquely transmitted signals from the SDA transmit antenna arrays and repeated from the repeater or a reflected version of the N uniquely coded signals reflected from the non-cooperative platform; a second processor located on the primary platform using electrical signals from the second receive antenna; and a first communication channel that communicates information from the SDA processor or the cooperative platform processor to a primary platform processor. In this alternative embodiment, the SDA processor determines the angle of arrival at a cooperative platform relative to the SDA in the localized coordinate system using the relative phase information from the N uniquely transmitted signals that are re-transmitted by the repeater.

In this alternative embodiment, the SDA processor determines the time of arrival of at least one of the N uniquely coded signals transmitted by the SDA and re-transmitted by the repeater.

In this alternative embodiment, the SDA processor determines range or distance from the SDA to the cooperative platform using the time of arrival of at least one of the N uniquely coded signals transmitted by the SDA and re-transmitted by the repeater.

In this alternative embodiment, the SDA processor determines the Doppler frequency of at least one of the N uniquely coded signals transmitted by the SDA and re-transmitted by the repeater.

In this alternative embodiment, the SDA processor determines range rate using the Doppler frequency of at least one of the N uniquely coded signals transmitted by the SDA and re-transmitted by the repeater.

In this alternative embodiment, the second processor determines an angle of arrival of the N uniquely coded signals at the primary platform relative to the SDA in the localized coordinate system using the relative phase information from the N uniquely transmitted signals transmitted from or reflected by the primary platform.

In this alternative embodiment, the second processor determines the time of arrival of the N uniquely transmitted SDA signals relative to the time of transmission.

In this alternative embodiment, the second processor determines the range of the primary platform relative to the SDA.

In this alternative embodiment, the second processor determines the angle of arrival of the cooperative platform relative to the SDA in the localized coordinate system using the N uniquely coded transmitted signals from the SDA that are transmitted by the repeater. In this alternative embodiment, the receiver processor determines the time of arrival of at least one of the N uniquely transmitted SDA signals re-transmitted by the repeater on the cooperative platform relative to the time of transmission from the SDA.

In this alternative embodiment, the second processor determines the position of the cooperative platform relative to the SDA using the clock on the primary platform.

In this alternative embodiment, the second processor determines the range rate of at least one of the N uniquely transmitted SDA signals re-transmitted by the repeater on the cooperative platform relative to the location of the SDA.

In this alternative embodiment, the second processor determines the clock alignment error (e.g., a time difference) between the SDA clock and a second receiver clock using two estimates of the range or distance from the SDA to the cooperative platform.

Furthermore, the second processor determines the clock latency between the SDA clock and the repeater clock using two estimates of range from the SDA to the cooperative platform.

Still further, the second processor aligns the second receiver clock with the SDA clock using estimates of clock alignment error and latency.

In this alternative embodiment, the second processor executes an optimal estimation algorithm that implements at least first order derivative states of the range from the SDA to the first receiver to determine the clock alignment error and latency.

In this second alternative embodiment, at least one of the group including the primary platform and the cooperative platform is or may be directed to a position relative to the SDA, as desired.

In this second alternative embodiment, the cooperative platform with the repeater and the primary platform with the receiver are the same platform.

In another alternative embodiment, the system further includes a non-cooperative platform (not shown) separate from the SDA and separate from the primary platform where the N uniquely transmitted signals by the SDA are reflected by the non-cooperative target.

A processor coupled to the primary platform receiver can be arranged to correct phase differences between the known phase differences in the N transmitted SDA signals and any phase difference detected in the received versions of the N transmitted SDA signals. This phase error calibration adjustment may be repeated periodically as desired. As disclosed, this adjustment corrects for errors in the estimated angles determined with respect to a normal vector extending from the plane of the SDA.

In the context of the present document, the SDA array may be arranged along one or more surfaces of an airborne or land-based vehicle. Such an SDA array in addition to the transmit antenna arrays includes one or more filters, analog front ends, signal converters, signal generators, memories, processors, amplifiers, and power supplies as described in U.S. Pat. No. 10,571,224 B2 the entire contents of which is hereby incorporated by reference.

In the context of the present document, a platform is a structure for supporting one or more antennas, filters, analog front ends, signal converters, memories, processors, amplifiers, and power supplies as may be desired. As described, at least one platform includes one or more of the described functional elements arranged as a repeater while one or more instances of the described elements are arranged as a receiver. Platforms may be autonomous or remotely controlled as may be desired. Platforms may be airborne or land-based vehicles.

In the context of the present document, primary and cooperative platforms are arranged to communicate with the SDA array. In contrast, a non-cooperative platform or target is an airborne or land-based vehicle that does not have a communication channel with the SDA (i.e., a non-cooperative platform or target does not share an information signal with any of the SDA array or the primary and cooperative platforms.

The aspects previously defined in this disclosure and further aspects of the disclosure are apparent from the examples of embodiment to be described hereinafter and are explained with reference to these examples of embodiment.

### BRIEF DESCRIPTION OF THE DRAWINGS

FIG. 1 shows the functional components that comprise an embodiment of a LPNT system according to an exemplary embodiment of the disclosure.

FIG. 2 shows the functional components of a system implementation of the CSC method according to an exemplary embodiment of the disclosure.

FIG. 3 illustrates the functional components of a system that can perform a step of the LTS method according to an exemplary embodiment of the disclosure.

FIG. 4 illustrates the functional components of a system that can perform a second step of the LTS method according to an exemplary embodiment of the disclosure.

FIG. 5 illustrates the functional components of a system that can perform a third step of the LTS method according to an exemplary embodiment of the disclosure.

FIG. 6 includes a functional block diagram of the SDA array of FIGS. 1-5.

FIG. 7 includes a functional block diagram of the cooperative platform of FIGS. 1-5.

FIG. 8 includes a functional block diagram of the primary platform of FIGS. 1-5.

FIG. 9 includes an embodiment of a CSC method as performed by the LPNT system in the embodiment of FIG. 2.

FIG. 10 includes an embodiment of a LTS method as performed by the LPNT system in the embodiment of FIG. 5.

### DETAILED DESCRIPTION OF ILLUSTRATED EMBODIMENTS

The illustrations in the drawings are schematically presented. In different drawings, similar or identical elements are provided with the same reference signs.

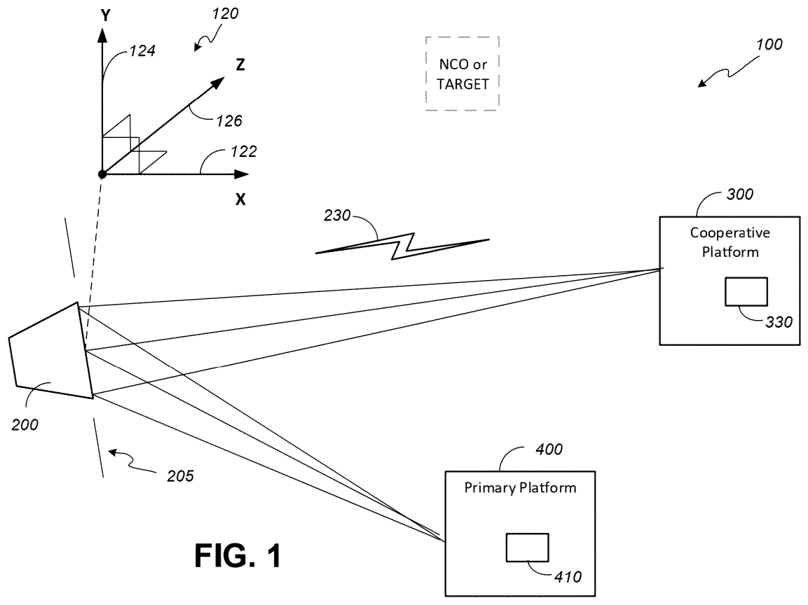

FIG. 1 schematically illustrates an environment with system components that enable a LPNT system 100. As shown, the LPNT system 100 includes an SDA array or system 200 separated from a repeater 330 on a cooperative platform 300 and a receiver or second receive antenna 410 located on a primary platform 400. The SDA array 200 transmits a set of N uniquely coded signals where the relative phase differences between the N signals is known. The SDA array 200 defines a local coordinate system 120 with a plane 205 defined by the multiple transmit antenna arrays 212 of the SDA array 200 defining an x-axis 122, a y-axis 124, two orthogonal axes and a normal vector 126 extending from the plane 205 defining a third axis of the SDA defined local coordinate system 120. As further illustrated in FIG. 1 the SDA array 220 may be arranged to provide a communication channel 230 or link to share information with the cooperative platform 300 or the repeater 330 in addition to the transmitted versions of the N uniquely coded signals which are directed in a broadcast region or field that contains both the cooperative platform 300 and its repeater 330 and the primary platform 400 and its second receive antenna 410.

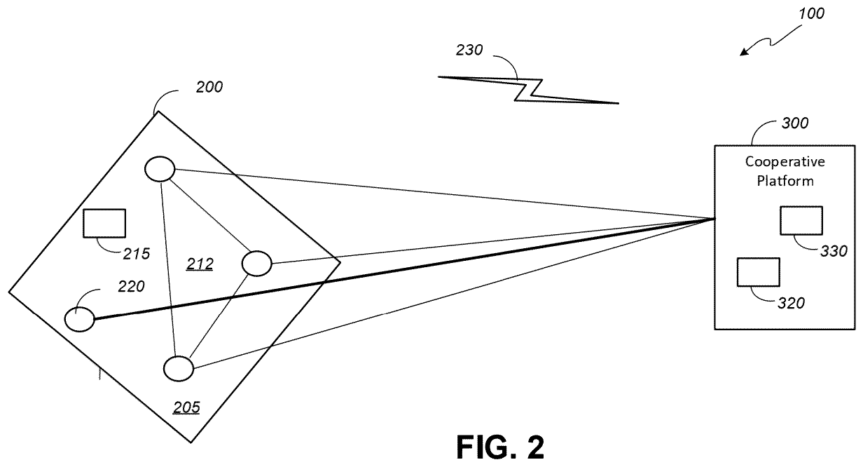

FIG. 2 shows the functional components of a system implementation of the CSC method. As described, the cooperative platform 300 and its repeater 330 receives the N uniquely coded signals from the respective antennas of the SDA array 200. A first processor 320 on the cooperative platform 300 combines the received signals and retransmits a combination signal over the communication channel 230 in the direction of the SDA array 200 or to an angle calibration antenna 220 proximal to the transmit antenna arrays 612 of the SDA array 200. An SDA processor 215 receives the signals and generates the combination or combined signal with N correlation filters using the N uniquely coded signals as reference signals for the correlation process. Thus, the relative phases of the received versions of the N signals are determined through the correlation process performed by the first processor 320. Using the known relative phases and the measured relative phases, an angle calibration bias factor can be determined and removed from the erred angle estimates.

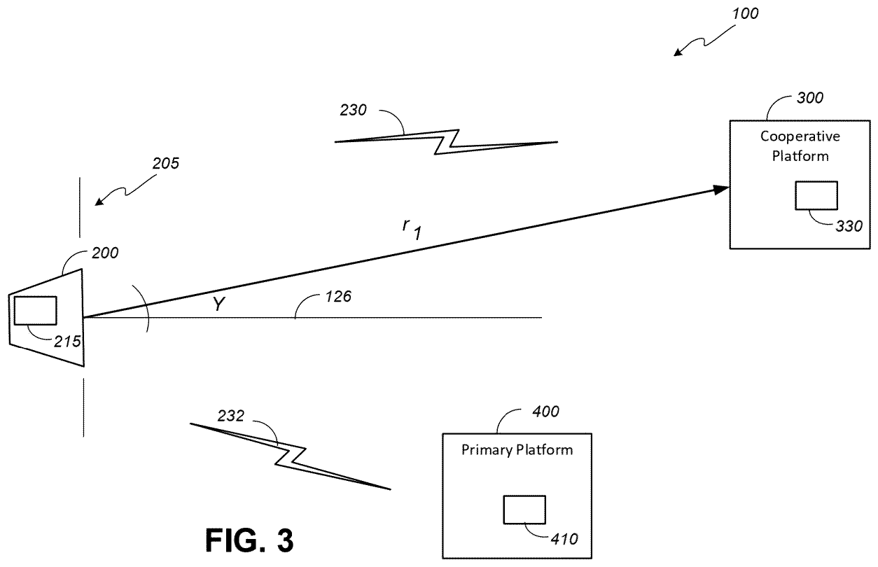

FIG. 3 illustrates the functional components of a LPNT system 100 that can perform a first step of the LTS method according to an exemplary embodiment of the disclosure. The angle γ is defined by the normal vector 126 extending from the plane 205 of the SDA array 200 and a range vector r₁ which defines the distance between the plane 205 of the SDA array 200 and the cooperative platform 300. In a first step of the LTS method the location of the repeater 330 on the cooperative platform 300 at the second receive antenna 410 located on the primary platform 400 is determined using a clock signal from the SDA array 200. To accomplish this step, the SDA array 200 performs as a radar by using the 2-way signal from the repeater 330 to determine the angle of arrival γ and the range of the repeater 330 in the SDA-based local coordinate system 120. The SDA processor 215 communicates the angle of arrival γ and the range r₁ to the primary platform receive antenna 410 using a radio frequency communication channel or data link 232.

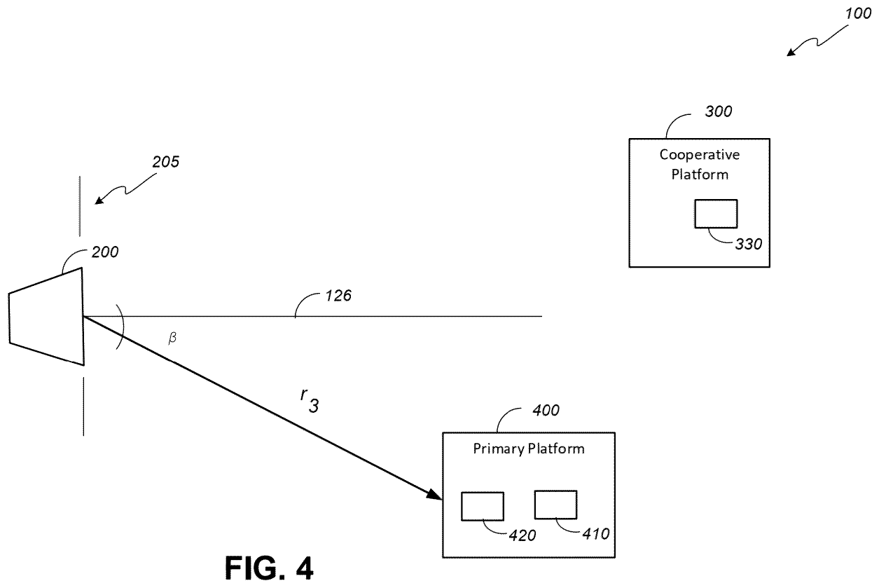

FIG. 4 illustrates the functional components of a LPNT system 100 that can perform a second step of the LTS method according to an exemplary embodiment of the disclosure. The angle β is defined by the normal vector 126 extending from the plane 205 of the SDA array 200 and a range vector r₃ which defines the distance between the plane 205 of the SDA array 200 and the primary platform or second receive antenna 410. The second step of the LTS method determines the location of the second receive antenna 410 on the primary platform 400 using the N number of transmitted signals from the SDA array 200 and received by the second receive antenna 410 on the primary platform 400. To accomplish this step, the relative phases of the N signals and the time of arrival of at least one of the N signals relative to the plane 205 of the SDA array 200 is determined by the second processor 420 using the signals received by the second receive antenna 410.

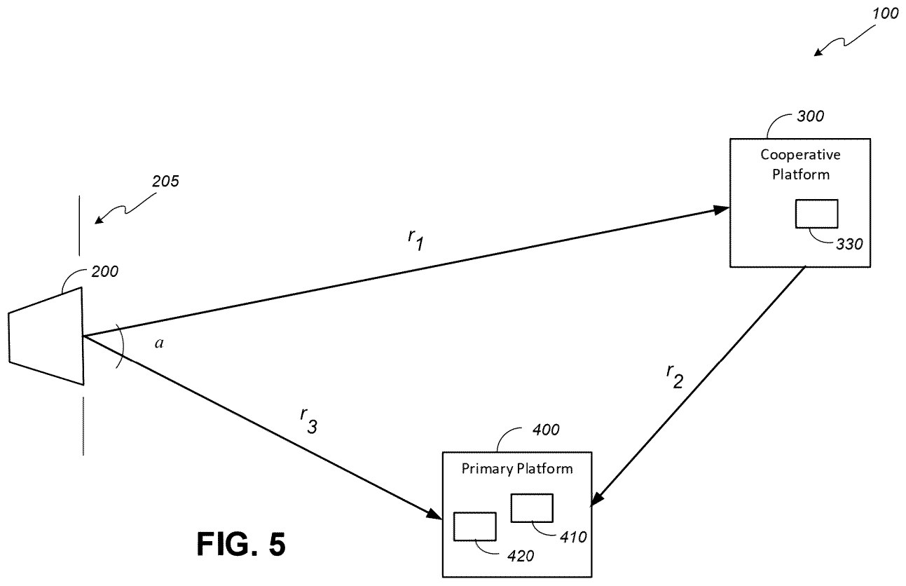

FIG. 5 illustrates the functional components of a LPNT system 100 that can perform a third step of the LTS method according to an exemplary embodiment of the disclosure. The third step of the LTS method determines the range r₃ using the time of arrival of a signal from the SDA array 200 received at the primary platform 400 using a clock signal on the primary platform 400. The angle α is defined by the range vector r₁ extending from the plane 205 of the SDA array 200 and ending at the first receive antenna 310 on the cooperative platform 300 and a range vector r₃ extending from the plane 205 of the SDA array 200 and ending at the second receive antenna 410 of the primary platform 400. More specifically, cos (a) is defined as the dot product of the unit range vector r₁/norm (r₁) and the unit range vector r₃/norm (r₃). A third range vector r₂ is defined by the distance between the cooperative platform 300 and the primary platform 400 in the local coordinate system 120.

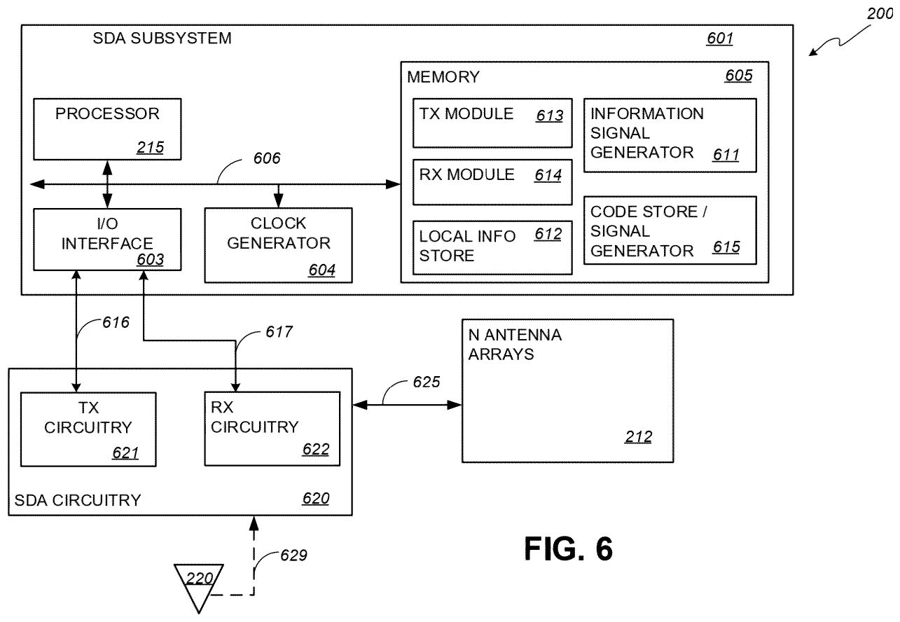

FIG. 6 includes a functional block diagram of the SDA array 200 of FIGS. 1-5. In the illustrated embodiment, the SDA array 200 includes SDA subsystem 601, SDA circuitry 620 and N antenna arrays 612. As indicated, the N antenna arrays 612 define the coordinate system 120 introduced in FIG. 1. The SDA subsystem 601 includes a processor 215, input/output (I/O) interface 603, clock generator 604 and memory 605 coupled to one another via a bus or local interface 606. The bus or local interface 606 can be, for example but not limited to, one or more wired or wireless connections, as is known in the art. The bus or local interface 606 may have additional elements, which are omitted for simplicity, such as controllers, buffers (caches), drivers, repeaters, and receivers (e.g. circuit elements), to enable communications. In addition, the bus or local interface 606 may include address, control, power and/or data connections to enable appropriate communications among the components.

The processor 215 executes software (i.e., programs or sets of executable instructions), particularly the instructions in the information signal generator 611, TX module 613, RX module 614, and code store/signal generator 215 stored in the memory 605. The processor 215 in accordance with one or more of the mentioned generators or modules may retrieve and buffer data from the local information store 612. The processor 215 can be any custom made or commercially available processor, a central processing unit (CPU), an auxiliary processor among several processors associated with the SDA subsystem 601, a semiconductor-based microprocessor (in the form of a microchip or chip set), and application specific integrated circuit (ASIC) or generally any device for executing instructions.

The clock generator 604 provides one or more periodic signals to coordinate data transfers along bus or local interface 606. The clock generator 604 also provides one or more periodic signals that are communicated via the I/O interface 603 over connection 616 to the TX circuitry 621. In addition, the clock generator 604 also provides one or more periodic signals that are communicated via the I/O interface 603 over connection 617 to the RX circuitry 622. The one or more periodic signals forwarded to the SDA circuitry 620 enable the SDA array 200 to coordinate the transmission of the N uniquely coded signals to the N antenna arrays 212 via the connections 625 and the reception of informative signals from the primary platform 400 and the cooperative platform 300 via the N antenna arrays 212 or the optional connection 629. The I/O interface 603 includes controllers, buffers (caches), drivers, repeaters, and receivers (e.g. circuit elements), to enable communications between the SDA subsystem 601 and the SDA circuitry 620.

The memory 605 can include any one or combination of volatile memory elements (e.g., random-access memory (RAM), such as dynamic random-access memory (DRAM), static random-access memory (SRAM), synchronous dynamic random-access memory (SDRAM), etc.) and non-volatile memory elements (e.g., read-only memory (ROM)). Moreover, the memory 605 may incorporate electronic, magnetic, optical, and/or other types of storage media. Note that the memory 605 can have a distributed architecture, where various components are situated remote from one another, but can be accessed by the processor 215.

The information signal generator 611 includes executable instructions and data that when buffered and executed by the processor 215 generate and forward a signal or signals that communicate at least P electrical measurements made by the first receiver in response to the N uniquely coded signals transmitted by the N transmit arrays 212, where P is a positive integer. Alternatively, the information signal generator 611 includes executable instructions and data that when buffered and executed by the processor 215 generate and forward a signal or signals that communicate a position and motion (if any) of the platforms 330, 400 in the coordinate system 120.

The code store/signal generator 615 includes executable instructions and data that when buffered and executed by the processor 215 generate and forward a set of N signals that are encoded or arranged in a manner that enable a receiver of the N signals, such as, the receiver 410 or other receivers (not shown) to separately identify each of the N signals at location separate from the SDA array 200. The TX module 613 includes executable instructions and data that when buffered and executed by the processor 215 enable the SDA subsystem 601 to communicate a set of uniquely identifiable signals to a spatially distributed architecture (SDA) of N antenna arrays 212, where N is a positive integer greater than or equal to two, the arrangement of the N antenna arrays defining the coordinate system 120. The TX module 613 includes executable instructions and data that when buffered and executed by the processor 215 enable the SDA subsystem 601 to receive reflected or repeated versions of the set of uniquely identifiable signals transmitted from the SDA of N antenna arrays 212 and repeated by the cooperative platform 300 and determine a location in the first coordinate system 120 based on a respective time and phase of reflected versions of the uniquely identified signals and an angular position and a range of the receiver 410 relative to an origin of the first coordinate system 120.

Preferably, the processor 215 is arranged to determine an angle of incidence of the combination signal as received from the repeater 330 on the cooperative platform 300 with respect to the normal vector 126 extending from the plane 205 of the SDA transmit antennas 212. In addition, the SDA processor 215 is arranged to determine a time of arrival of at least one of the N uniquely coded signals transmitted by the SDA and re-transmitted by the repeater 330. The SDA processor 215 is configured to also determine the range and range rate from the SDA array 200 to the cooperative platform 300 using the time of arrival of at least one of the N uniquely coded signals transmitted by the SDA array 200 and re-transmitted by the repeater 330. In this regard, the range rate may be derived from the Doppler frequency of at least one of the N uniquely coded signals transmitted by the SDA array 200 and re-transmitted by the repeater 330.

As disclosed, the SDA array 200 communicates the angle of incidence, γ, the estimate of the range and range rate of distance between the SDA array 200 and the cooperative platform 300 to the primary platform 400 via the communication link 232.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

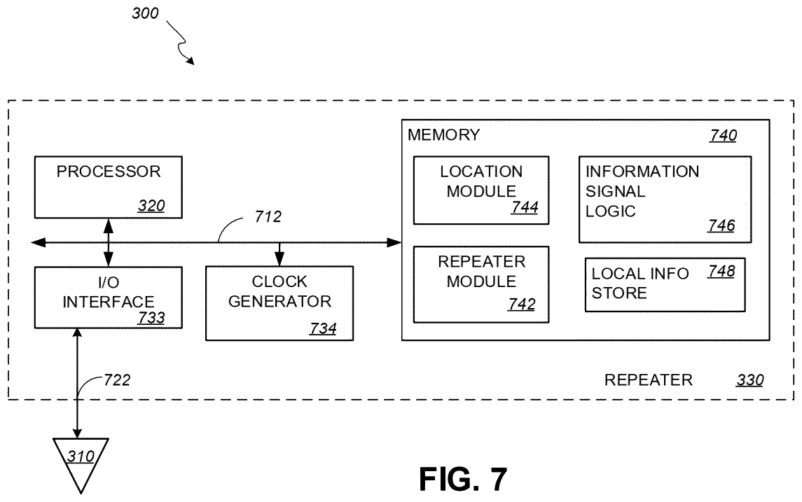

FIG. 7 includes a functional block diagram of the cooperative platform 300 of FIGS. 1-5. In the illustrated embodiment, the repeater 330 includes a processor 320, I/O interface 733, clock generator 734 and memory 740 coupled to one another via a bus or local interface 712. The bus or local interface 712 can be, for example but not limited to, one or more wired or wireless connections, as is known in the art. The bus or local interface 712 may have additional elements, which are omitted for simplicity, such as controllers, buffers (caches), drivers, repeaters, and receivers (e.g. circuit elements), to enable communications. In addition, the bus or local interface 712 may include address, control, power and/or data connections to enable appropriate communications among the components.

The processor 320 executes software (i.e., programs or sets of executable instructions), particularly the instructions in the location module 744, repeater module 742 and information signal logic 746 stored in the memory 740. The processor 320 in accordance with one or more of the mentioned modules or logic may retrieve and buffer data from the local information store 748. The processor 320 can be any custom made or commercially available processor, a CPU, an auxiliary processor among several processors associated receiver repeater 330, a semiconductor-based microprocessor (in the form of a microchip or chip set), an ASIC or generally any device for executing instructions.

The clock generator 734 provides one or more periodic signals to coordinate data transfers along bus or local interface 712. The clock generator 734 also provides one or more periodic signals that are communicated via the I/O interface 733 over connection 722 to communicate wirelessly via antenna(s) 310. In addition, the clock generator 734 also provides one or more periodic signals that enable the repeater 330 to coordinate the transmission of informative signals. The I/O interface 733 includes controllers, buffers (caches), drivers, repeaters, and receivers (e.g. circuit elements), to enable communications between the repeater 330 and the SDA subsystem 601.

The memory 740 can include any one or combination of volatile memory elements (e.g., RAM, DRAM, SRAM, SDRAM, etc.) and non-volatile memory elements (e.g., ROM). Moreover, the memory 740 may incorporate electronic, magnetic, optical, and/or other types of storage media. Note that the memory 740 can have a distributed architecture, where various components are situated remote from one another, but can be accessed by the processor 320.

The location module 744 includes executable instructions and data that when buffered and executed by the processor 320 generate and forward information to information signal logic 746 such as at least P electrical measurements made by the repeater 330 in response to the N uniquely coded signals transmitted by the N transmit arrays 212, where P is a positive integer. Alternatively, the location module 744 may be arranged to forward a location in X, Y, Z coordinates relative to the origin of the coordinate system 120.

Repeater module 742 includes executable instructions and data that when buffered and executed by the processor 320 determine and forward motion information to information signal logic 746 such motion information may include velocity vector values in X, Y, Z coordinates relative to the local coordinate system 120.

Preferably, the processor 320 is arranged to determine the relative phases among the combined waveforms in the combination signal transmitted by the at least one of the transmit antenna arrays or the ACA proximal to the SDA.

In an embodiment, the processor 320 is configured to compare the relative phases of the N component signals in the combined signal transmitted by the antenna 220 to determine the angular location of the first receive antenna 310 in the local coordinate system 120. The processor 320 is arranged to perform a calibration of the relative interferometric phases by comparing one or more of the relative signal phases in the received combination signal and the known relative phases of the N uniquely coded signals to derive an angle calibration factor. As disclosed, the angle calibration factor may be applied to adjust angle estimates. In turn, the angle calibration factor may be communicated to the SDA array 200 through communication channel 230.

Information signal logic 746 includes executable instructions and data that when buffered and executed by the processor 320 generate and forward a signal or signals that communicate a position and motion (if any) of the repeater 330 in the coordinate system 120.

As indicated, local information store 748 may include data describing a local map, chart, floorplan, etc. The local information store 748 may include locations of fixed items in the coordinate system 120 defined by the SDA array 200. The included data may also define one or more preferred paths, routes, or channels for the cooperative platform 300 to use. In addition, the data in local information store 748 may receive updates or real-time information regarding the environment. Such real-time updates may include the position of both fixed structures and other platforms in the vicinity of the cooperative platform 300. In some arrangements, the local information store 748 may also receive information including the position and motion (if any) of one or more non-cooperative platforms in the vicinity of the cooperative platform 300.

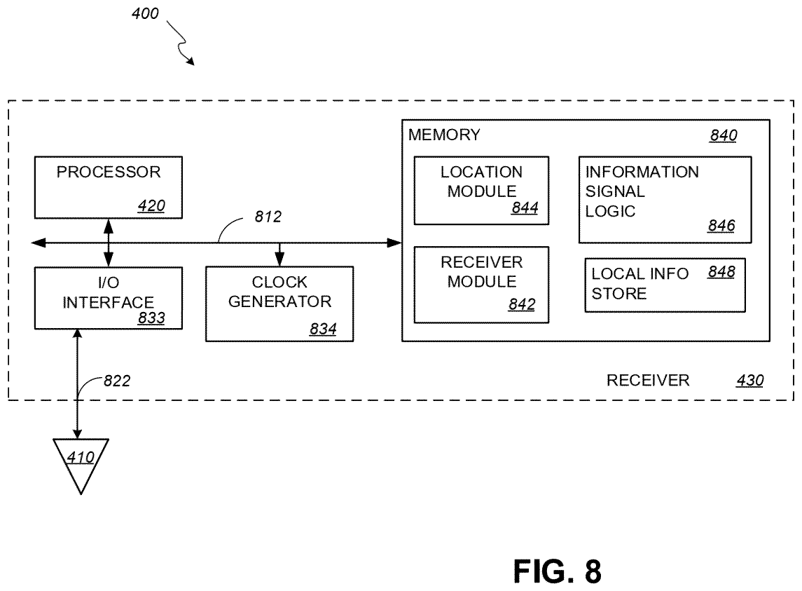

FIG. 8 includes a functional block diagram of the primary platform 400 of FIGS. 1-5. In the illustrated embodiment, the primary platform 400 includes a processor 420, I/O interface 833, clock generator 834 and memory 840 coupled to one another via a bus or local interface 812. The bus or local interface 812 can be, for example but not limited to, one or more wired or wireless connections, as is known in the art. The bus or local interface 812 may have additional elements, which are omitted for simplicity, such as controllers, buffers (caches), drivers, repeaters, and receivers (e.g. circuit elements), to enable communications. In addition, the bus or local interface 812 may include address, control, power and/or data connections to enable appropriate communications among the components.

The processor 420 executes software (i.e., programs or sets of executable instructions), particularly the instructions in the location module 844 and the receiver module 842 stored in the memory 840. The processor 420 can be any custom made or commercially available processor, a CPU, an auxiliary processor among several processors associated with the primary platform 400, a semiconductor-based microprocessor (in the form of a microchip or chip set), an ASIC or generally any device for executing instructions.

The clock generator 834 provides one or more periodic signals to coordinate data transfers along bus or local interface 812. The clock generator 834 also provides one or more periodic signals that are communicated via the I/O interface 833 over connection 822 to communicate wirelessly via antenna(s) 410. In addition, the clock generator 834 also provides one or more periodic signals that enable the primary platform 400 to coordinate the transmission of informative signals. The I/O interface 833 includes controllers, buffers (caches), drivers, repeaters, and receivers (e.g. circuit elements), to enable communications between the primary platform 400 and the SDA array 200.

The memory 840 can include any one or combination of volatile memory elements (e.g., RAM, DRAM, SRAM, SDRAM, etc.) and non-volatile memory elements (e.g., ROM). Moreover, the memory 840 may incorporate electronic, magnetic, optical, and/or other types of storage media. Note that the memory 840 can have a distributed architecture, where various components are situated remote from one another, but can be accessed by the processor 420.

The location module 844 includes executable instructions and data that when buffered and executed by the processor 420 generate and forward information to information signal logic 846 such as a primary platform location in X, Y, Z coordinates relative to the local coordinate system 120. The receiver module 842 includes executable instructions and data that when buffered and executed by the processor 420 determine and forward motion information to information signal logic 846. Such motion information may include velocity vector values in X, Y, Z coordinates responsive to motion of the primary platform 400 relative to the local coordinate system 120. In addition, the position and motion of the cooperative platform 300 coordinates of the cooperative platform 300 in the local coordinate system 120 may be determined.

Preferably, the processor 420 is arranged to determine an angle of arrival, B, of the N uniquely coded signals at the primary platform 400 relative to the SDA array 200 in the localized coordinate system 120 using the relative phase information from the N uniquely transmitted signals transmitted from the SDA array 200. The processor 420 is further configured to determine the time of arrival of the N uniquely transmitted SDA signals relative to a time of transmission. In turn, the processor 420 determines the range of the primary platform 400 relative to the SDA array 200.

Specifically, the processor 420 determines the position of the receiver 410 on the primary platform 400 by determining the relative phases of the N uniquely coded signals received at the primary platform 400 and the time of arrival of at least one of the N uniquely coded signals.

In addition, the processor 420 is arranged to determine the time of arrival of at least one of the N uniquely transmitted SDA signals re-transmitted by the repeater 330 on the cooperative platform 300 relative to the time of transmit by the SDA array 200. The processor 420 determines the position of the cooperative platform 300 and more specifically, the repeater 330 relative to the SDA array 200 using the clock signal on the primary platform 400.

Furthermore, the processor 420 determines the range and range rate of at least one of the N uniquely transmitted SDA signals re-transmitted by the repeater 330 on the cooperative platform 300 relative to the location of the SDA 200. Once the processor 420 has collected the angles γ and β, the range r₃ and the range sum of r₁+r₂, the processor 420 can derive an estimate of the distance r₁ using trigonometry and the primary platform clock signal.

Thereafter, the processor 420 determines a clock alignment error between the SDA clock signal and the primary platform clock signal using two estimates of the range r₁ or distance from the SDA array 200 to the cooperative platform 300. Preferably, the processor 420 is configured to align the primary platform clock signal with the SDA clock signal using estimates of the clock alignment error and latency. In this regard, the processor 420 is arranged to use an optimal estimation algorithm that implements at least first order derivative states of the range from the SDA array 200 to the receiver 410 to determine the clock alignment error and latency.

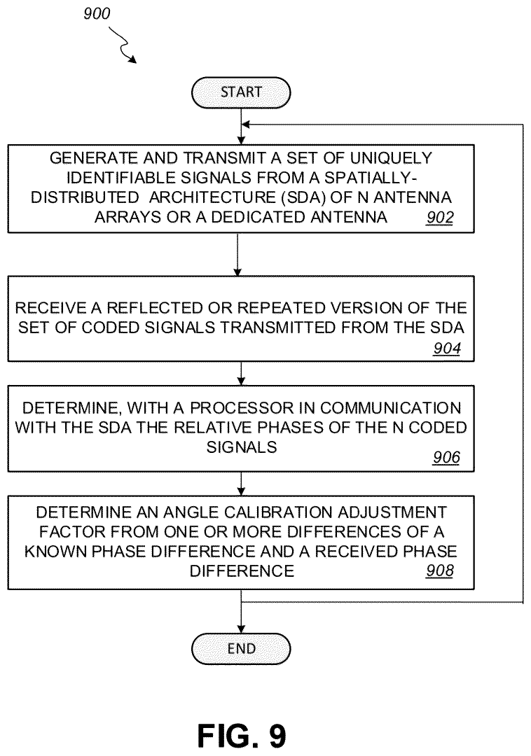

FIG. 9 includes an embodiment of a CSC method 900 as performed by the LPNT system 100 in the embodiment of FIG. 2. As illustrated in the flow diagram in a first step 902 a set of uniquely identifiable signals are transmitted from a corresponding set of N antenna arrays or transmit antennas. Alternatively, the uniquely identifiable signals may be combined and transmitted from a dedicated calibration antenna proximal to the N antenna arrays. As described, the members of the set of uniquely identified signals are separated in phase by known phase differences between the individual members of the set of signals.

Thereafter, in a step 904 repeated versions of the set of uniquely identifiable signals or a repeated version of the of the combined signal are received at the transmit antenna arrays 612 of the SDA array 200.

Next, in a third step 906 the SDA processor 215 or a processor coupled to the SDA array 200 determines the relative phase differences of the repeated versions of the set of uniquely identifiable signals or a repeated version of the of the combined signal.

In a final step 908, the SDA processor 215 or a processor coupled to the SDA array 200 determines an angle calibration adjustment factor as a function of one or more of the differences between the known phase differences and a measured or received phase difference from the relative phase differences of the repeated versions of the set of uniquely identifiable signals or a repeated version of the of the combined signal.

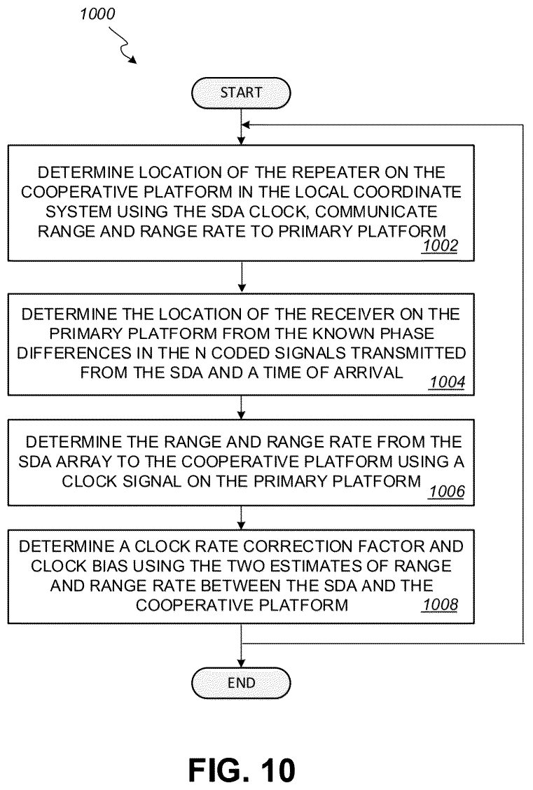

FIG. 10 includes an embodiment of a LTS method 1000 as performed by the LPNT system 100 in the embodiment of FIG. 5. In a first step 1002 the SDA processor 215 determines the position of the repeater 330 on the cooperative platform 300 in the local coordinate system 120 using the SDA clock. This first estimate of the range r₁ between the SDA array 200 and the cooperative platform 300 is made with the SDA clock and is communicated along with a range rate in a data link 232 to the primary platform 400.

In a second step 1004, the second processor 420 determines the location of the receiver 410 on the primary platform 400 from the known phase differences in the N coded signals transmitted from the SDA array 200 and a time of arrival at the primary platform 400.

In a third step 1006, the second processor 420 uses a clock signal on the primary platform 400 to determine an estimate of the range and range rate from the SDA array 200 to the cooperative platform 300. This is accomplished with the angle γ (FIG. 3), the angle β (FIG. 4), where α (FIG. 5) is the sum of the angles γ and β, and the measured distances or ranges r₃ and the range sum of r₁+r₂. With the mentioned parameters, the processor 420 can derive an estimate of the distance r₁ using trigonometry and the primary platform clock signal.

Thereafter, as indicated in step 1008, the second processor 420 determines a clock rate correction factor and/or a clock bias as a function of the range and range rate estimates of the distance between the SDA array 200 and the cooperative platform 300. Once the clock bias is determined, the clock signal on the primary platform 400 can be aligned to the clock signal on the SDA array 200. Range rate is used to determine the clock rate error and range is used to determine the clock bias error. If two clocks are running at different rates then they will measure the range rate differently and using this difference allows a clock rate correction to be made. If two clocks are biased (with respect to the other) then there will be a bias in their measurement of range which will allow a correction of the clock bias.

It should be noted that the term “comprising” does not exclude other elements or steps and the article “a” or “an” does not exclude a plurality. Also, elements described in association with different embodiments may be combined.

Implementation of the disclosure is not limited to the preferred embodiments shown in the figures. Instead, a multiplicity of variants is possible which variants use the solutions shown and the principle according to the disclosure.

### REFERENCE LABELS

100 LPNT system
120 local coordinate system
122 x-axis
124 y-axis
126 normal vector
200 SDA array (system)
205 plane
212 (multiple) transmit antenna arrays
215 SDA processor
220 angle calibration antenna
230 communication channel (between SDA and 1st processors)
232 communication channel (between SDA and 2nd processors)
300 cooperative platform
310 first receive antenna (cooperative platform)
320 first processor (cooperative platform)
330 repeater
400 primary platform
410 second receive antenna (primary platform)
420 second processor (primary platform)
430 receiver
601 SDA subsystem
603 I/O interface
604 clock generator
605 memory
606 bus
611 information signal generator
612 local info store
613 Tx module
614 Rx module
615 code store/signal generator
616 bus/connection
617 bus/connection
620 SDA circuitry
621 Tx circuitry
622 Rx circuitry
625 bus/connection
629 bus/connection
712 bus
722 bus/connection
733 I/O interface
734 clock generator
740 memory
742 repeater module
744 location module
746 information signal logic
748 local info store
812 bus
822 bus/connection
833 I/O interface
834 clock generator
840 memory
842 receiver module
844 location module
846 information signal logic
848 local info store
900 CSC method
902 first step
904 second step
906 third step
908 fourth step
1000 LTS method
1002 first step
1004 second step
1006 third step
1008 fourth step
   γ angle of incidence (combination signal from repeater)
   β angle of arrival (at the primary platform)
   α angle between vectors r₁ and r₃

1. A system for localized position, navigation, and timing, the system comprising:
a cooperative platform including:
a first receive antenna, receiving a set of N uniquely coded signals transmitted by a spatially-distributed architecture (SDA) of transmit antenna arrays, the SDA having at least N members of antenna arrays separate from each other, the N members of antenna arrays transmitting uniquely coded signals, respectively, where the relative phases among the N uniquely coded signals is known, where N is an integer greater than or equal to two;
a first processor in communication with the first receive antenna, wherein the N transmitted SDA signals are processed to determine the interferometric phase differences among the N transmitted SDA signals as received at the first receive antenna;
a repeater coupled with the first receive antenna, the repeater transmitting the set of N uniquely coded signals as received at the first receive antenna or a reflective non-cooperative platform reflecting the set of N uniquely coded signals;
the SDA of transmit antenna arrays, where a position and orientation of the antenna arrays of the SDA identify a localized coordinate system consisting of at least two orthogonal axes;
wherein at least one of the transmit antenna arrays or an angle calibration antenna (ACA) proximal to the SDA combines and transmits a combination signal including the set of N uniquely coded signals and receives the combination signal from the repeater or a reflected version of the N uniquely coded signals; and
an SDA processor in communication with the at least one of the transmit antenna arrays or the ACA proximal to the transmit antenna arrays, the SDA processor arranged to determine an angle of incidence of the combination signal as received from the repeater.

2. The system of claim 1, where the relative phases among the combined waveforms in the combination signal transmitted by the at least one of the transmit antenna arrays or the ACA proximal to the SDA are computed by the first processor.

3. The system of claim 2, wherein the relative phases among the combined waveforms in the combination signal transmitted by the at least one of the transmit antenna arrays or the antenna proximal to the SDA are compared with the known relative phases.

4. The system of claim 2, wherein the first processor uses interferometric phase differences among the N uniquely coded signals and determines the angular location of the first receive antenna in the localized coordinate system.

5. The system of claim 4, wherein a calibration of the relative interferometric phases is achieved using a comparison of the relative signal phases in the received combination signal and the known relative phases of the N uniquely coded signals to derive an angle calibration factor.

6. The system of claim 5, wherein the angle calibration factor is used to adjust angle estimates.

7. The system of claim 1, wherein the SDA array, the ACA antenna, and the first receive antenna are collocated and the N transmitted SDA signals are reflected from the reflective non-cooperative platform or reradiated from a cooperative platform.

8. The system of claim 1, further comprising:
a second receive antenna located on a primary platform that receives the N uniquely transmitted signals transmitted from the SDA and repeated from the repeater or a reflected version of the N uniquely transmitted signals from the non-cooperative platform;
a second processor located on the primary platform using electrical signals from the second receive antenna; and
a first communication channel that communicates information from the SDA processor to the second processor;
wherein the SDA processor determines the angle of arrival at a cooperative platform relative to the SDA in the localized coordinate system using the relative phase information from the N uniquely transmitted signals that are re-transmitted by the repeater.

9. The system of claim 8, wherein the SDA processor determines the time of arrival of at least one of the N uniquely coded signals transmitted by the SDA and re-transmitted by the repeater.

10. The system of claim 9, wherein the SDA processor determines range and range rate from the SDA to the cooperative platform using the time of arrival of at least one of the N uniquely coded signals transmitted by the SDA and re-transmitted by the repeater.

11. The system of claim 8, wherein the SDA processor determines the Doppler frequency of at least one of the N uniquely coded signals transmitted by the SDA and re-transmitted by the repeater.

12. The system of claim 11, wherein the SDA processor determines range rate using the Doppler frequency of at least one of the N uniquely coded signals transmitted by the SDA and re-transmitted by the repeater.

13. The system of claim 12, wherein the SDA array communicates the range and range rate of the repeater on the cooperative platform to the primary platform.

14. The system of claim 8, wherein the second processor determines an angle of arrival of the N uniquely coded signals at the primary platform relative to the SDA in the localized coordinate system using the relative phase information from the N uniquely transmitted signals transmitted from the SDA.

15. The system of claim 14, wherein the second processor determines the time of arrival of the N uniquely transmitted SDA signals relative to a time of transmission.

16. The system of claim 15, wherein the second processor determines the range of the primary platform relative to the SDA.

17. The system of claim 16, wherein the second processor determines the position of the receiver on the primary platform by determining the relative phases of the N uniquely coded signals received at the primary platform and the time of arrival of at least one of the N uniquely coded signals.

18. The system of claim 16, further comprising at least one of the following:
wherein the second processor determines the angle of arrival of the cooperative platform relative to the SDA in the localized coordinate system using the N uniquely coded transmitted signals from the SDA that are transmitted by the repeater;
wherein the second processor determines the time of arrival of at least one of the N uniquely transmitted SDA signals re-transmitted by the repeater on the cooperative platform relative to the time of transmit by the SDA;
wherein the second processor determines the position of the cooperative platform relative to the SDA using the clock on the primary platform;
wherein the second processer determines the range and range rate of at least one of the N uniquely transmitted SDA signals re-transmitted by the repeater on the cooperative platform relative to the location of the SDA;
wherein the second processor determines the clock alignment error between a first receiver clock and a second receiver clock using two estimates of the range or distance from the SDA to the cooperative platform;
wherein the second processor aligns the second receiver clock with the SDA clock using estimates of the clock alignment error and latency;
wherein the second processor uses an optimal estimation algorithm that implements at least first order derivative states of the range from the SDA to the first receiver to determine the clock alignment error and latency.

19. The system of claim 18, wherein at least one of a group including the primary platform and the cooperative platform is directed to a position relative to the SDA.

20. The system of claim 18, wherein the cooperative platform and the primary platform are the same platform.
